(19) United States
(12) Patent Application Publication
(10) Pub. No.: US 2006/0013418 A1
(43) Pub. Date: Jan. 19, 2006

(54) 5.1 channel digital surround earphone

(76) Inventor: Congyu Yan, Jiayi City (CN)

Correspondence Address: NIKOLAI & MERSEREAU, P.A., 900 SECOND AVENUE SOUTH, SUITE 820, MINNEAPOLIS, MN, 55402, US

(21) Appl. No.: 10/529,061

(22) PCT Filed: Jul. 21, 2003
(86) PCT No.: PCT/CN03/00581

§ 371 Date: Mar. 24, 2005

(30) Foreign Application Priority Data
Sep. 27, 2002 (CN) 021348375

(51) Int. Cl. H04R 5/02

(52) U.S. Cl. 381/309; 381/307

(57) ABSTRACT

The present invention relates to the technology field of electronic product, more particularly to a 5.1 channel digital surround earphone. It includes a earphone main body and a line-controller. There is a connecting line between the earphone main body and the line controller, input port of the line-controller is connected with a power amplifier box. The power amplifier includes power supply input unit, regulating filter circuit, amplifying circuit, and 5.1 channel signal input port. External power is inputted to the regulating filter circuit through the power supply input unit, amplifying circuit is applied by the output of the regulating filter circuit, the input port of the amplifying circuit is connected to the 5.1 channel signal input port, and the output port of the amplifying circuit is connected to the line-controller. The present invention can improve the s/n and reduce the distortion ratio by the power amplifying and filtering of the power amplifier box, and it can achieve fine playback effect, alt behaving sufficiently mediant and bass sounding comfortably, having fine digital surround effect. And the earphone adopts an open-type design of earpieces, so that sounds clearly and feels comfortable with the earphone on head, and it will not bother others in using.

### BACKGROUND OF THE INVENTION

1. Field of the Invention

The invention relates to an electronic product technology and particularly to a 5.1 sound channel digital surround earphone.

2. Description of the Prior Art

With constant developments of electronic technology, people have a higher demand on the audio effect. Audio devices have progressed from monotone, stereo system to Dolby Pro-Logic system and digital surround system. After several years of developments, the present DVD has a greater capacity, can produce crisp images and generate real-like audio effect, and is easy to use. It becomes very popular. In general, when use DVD to play movies, a 5.1 sound channel player has to be used to achieve the optimal home theater effect. And six matching speakers have to be connected. The six speakers take a lot of space, and a lot of wiring is needed. It is not convenient to set up. Moreover, the sound being generated is too large, and often disturbs other people who want to rest.

Hence surround earphone has been developed and introduced on the market. But it has speakers with only two sound channels. Using digital techniques, a virtual 5.1 sound channel surround effect can be achieved. However, positioning of the sound field, distance of sound source, sound channel discrete and the like cannot be established accurately. Hence the virtual effect of the earphone is still inferior to the actual 5.1 sound channel.

### SUMMARY OF THE INVENTION

Therefore the primary object of the present invention is to overcome the aforesaid disadvantages. The invention provides six sound channels and can be used with six sound channel decoded and output by AC-3/DTS. Hence positioning of the sound field, distance of sound source, and sound channel discrete can be presented accurately and clearly to enable the earphone to produce real-like 5.1 sound channel home theater digital surround effect.

The invention includes a line controller linking to an earphone body that has an input end connecting to a efficacy box. The power amplifier includes a power supply input unit, a voltage stabilization filter circuit, an amplification circuit and a 5.1 sound channel signal input port. An external power supply provides electric power through the power supply unit, voltage stabilization filter circuit, amplification circuit and an output end of the voltage stabilization filter circuit. The amplification circuit has an input end connecting to the voltage stabilization filter circuit, and an output end connecting to the line controller. The amplification circuit further has a power amplifying Integrated circuit which is connected to an audio bypass capacitor and a coupling capacitor. The power amplifier has a 5.1 sound track signal output port to be connected to other corresponding function devices. The output end of the amplification circuit has a 7-pin socket mating a 7-pin plug on a connection end of the line controller. The line controller has a switch for switching CD and DVD, and a sound volume potentiometer.

Through power amplification and filtering provided by the power amplifier, signal noise ratio increases, distortion is reduced, replay effect improves, treble and medium may be fully reproduced, and medium and bass effect is desirable, and digital surround effect is enhanced. Moreover, the earphone adopts an open type design. The sound is clear and crisp. And it does not annoy other people when in use.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the principle of the invention;

FIG. 2 is a schematic view of the invention; and

FIG. 3 is a circuit diagram of an embodiment of the invention.

### DESCRIPTION OF THE PREFERRED EMBODIMENTS

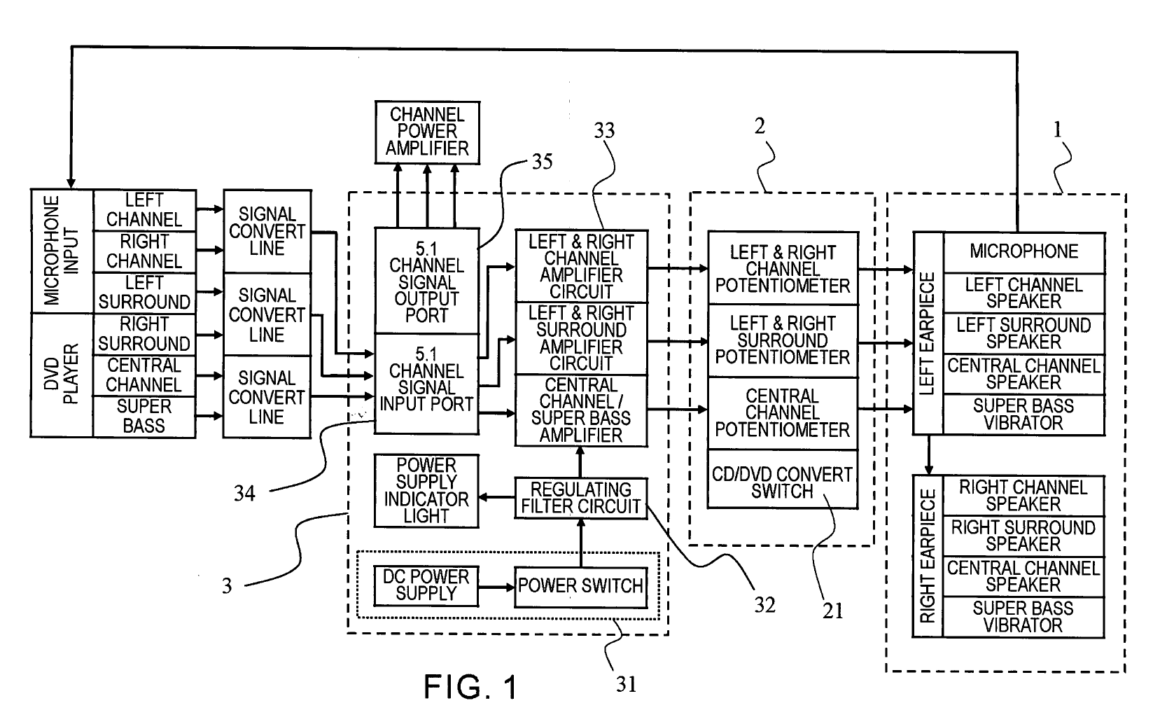

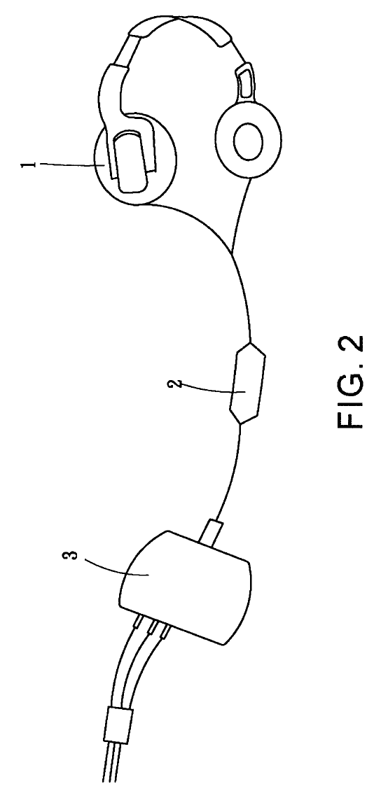

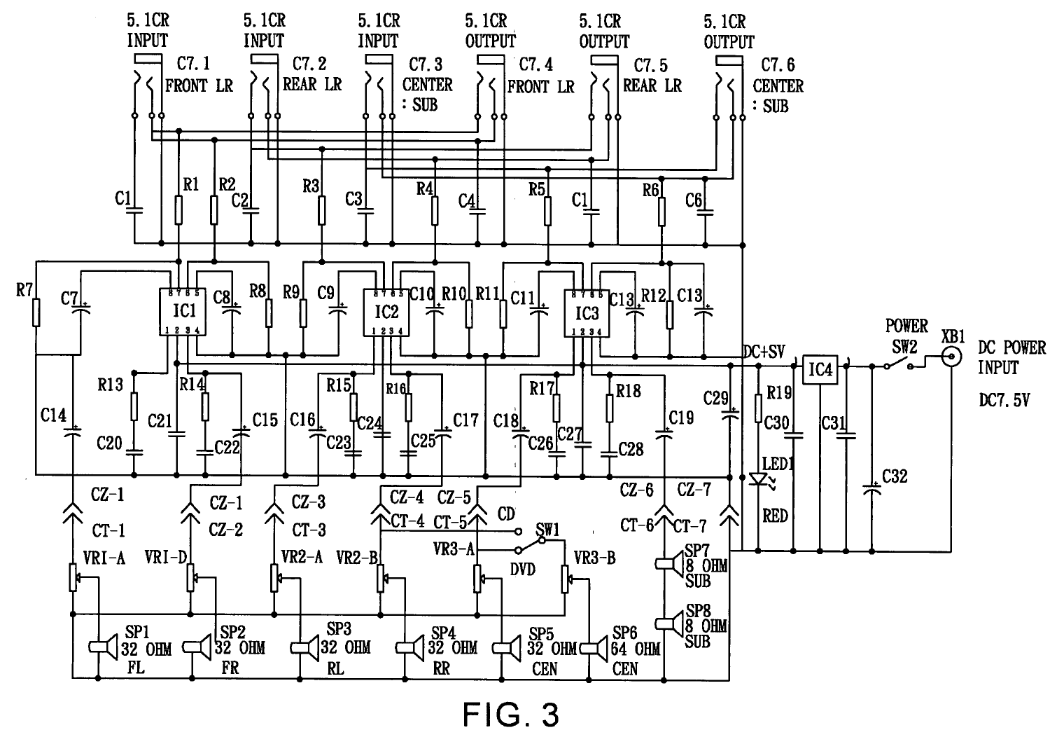

Referring to FIGS. 1, 2 and 3, the present invention includes an earphone body 1 and a line controller 2 that are connected through a conductive line. The line controller 2 has an input end connecting to a power amplifier 3. The power amplifier 3 includes a power supply input unit 31, a voltage stabilization filter circuit 32, an amplification circuit 33 and a 5.1 sound channel signal input port 34 and a 5.1 sound channel signal output port 35 for connecting to other corresponding function devices. An external power supply passes through the power supply input unit 31, voltage stabilization filter circuit 32, amplification circuit 33 and delivers through an output end of the voltage stabilization filter circuit 32. The amplification circuit 33 has a power amplifying Integrated circuit which is connected to an audio Bypass capacitor and a coupling capacitor. The amplification circuit 33 has an input end connecting to the 5.1 sound channel signal input port 34. The amplification circuit 33 has an output end connecting to the line controller 2. The output end of the amplification circuit 33 has a 7-pin socket mating a 7-pin plug of a connection end of the line controller 2. The line controller 2 has a switch 21 for switching CD and DVD and an audio volume potentiometer.

When in use, the power amplifier 3 is connected to an external power source of 7.5 VDC through a conductive line. Electric power is input through a XSIDC power supply socket, controlled by the switch and filtered by an electrolytic condenser C32. High frequency and interference signals are filtered out by a ceramic condenser C31. After being stabilized by an IC4 of the voltage stabilization filter circuit 32, the external power supply is modulated to a stable 5V AC. The stabilized power supply passes through a filter circuit formed by parallel coupling of an electrolytic condenser C29 and a ceramic condenser C30. Meanwhile, electric charge is performed to store energy. A portion of the power supply passes through a resistor R19 to reduce voltage and current to light a LED for power supply indication. The power supply has another portion delivering to IC1, IC2 and IC3 for normal operations. The power supply positive electrodes 2 of the IC1, IC2 and IC3 and power supply ground leg 4 are respectively coupled in parallel with condensers C21, C24 and C27 to eliminate the interference signals inducted on the power supply circuit, also provide a high frequency loop circuit for the amplification circuit 33 so that the IC1, IC2 and IC3 can function steadily without being interfered. After coding, a six-way 5.1 sound track audio signal (FL, FR, RL, RR, C and SUB) is input through sockets CZ1, CZ2 and CZ3 of the 5.1 sound track signal input end 34. First, condensers C1-C6 filter out lead line induction of the six routes and interference signal to the ground; next, divide voltage is formed through resistors R1-R12 that are coupled in parallel; then the audio signal can be amplified by IC1-IC3 smoothly. After power amplification by IC1-IC3, output is delivered through 1 and 3 legs of the IC1-IC3. After passing through a high frequency corrector formed by serial coupling resistors R13-R18 and condensers C20, C22, C23, C25, C26 and C28 to eliminate self-excited signals, the audio signal is output through coupled electrolytic condensers C14-C19 to 7-pin sockets CZ1-CZ7.

The line controller 2 is connected to 7-pin plugs CT1-CT7 which are coupled with the 7-pin sockets CZ1-CZ7, then the six 5.1 sound signals pass through three parallel coupled potentiometers VR1-VR3 of the line controller 2 to perform audio volume control of FL, FR, RL, RR and C, and drive speakers SP1-SP6 to generate corresponding sound. The central sound track broadcasts jointly through the speakers SP5 and SP6 in the left earphone and the right earphone. The super bass SUB is replayed through the serial coupled vibrators SP7 and SP8 in the left earphone and the right earphone to generate the super bass effect. In order to eliminate noises, the function input end of the SUB is coupled with an electrolytic condenser C13 in a parallel manner to form a branch circuit to remove the medium and high frequency signals, so that only the low frequency signal enters the amplifier.

The line controller 2 of the invention has the sound volume potentiometers VR1-VR3 and a switch SW1 to switch CD and DVD so that an optimal audio effect can be achieved when listening CD or DVD. The power amplifier 3 also has the 5.1 sound track signal output port 35 (CZ4-CZ6) to connect to other corresponding function devices to broadcast through the speakers so that many other people can listen at the same time. Moreover, the receiver of the earphone body 1 can directly receive sound and input to a DVD player to perform speaking and singing functions.

I claim:

1. A 5.1 sound channel digital surround earphone, comprising an earphone body and a line controller that are connected through a conductive line;
wherein the line controller has an input end connecting to a power amplifier, the power amplifier including a power supply input unit, a voltage stabilization filter circuit, an amplification circuit and a 5.1 sound channel signal input port, an external power supply providing electric power through the power supply input unit, the voltage stabilization filter circuit and the amplification circuit to an output end of the voltage stabilization filter circuit for delivering electric power, the amplification circuit having an input end connecting to the 5.1 sound channel signal input port and an output end connecting to the line controller.

2. The 5.1 sound channel digital surround earphone of claim 1, wherein the power amplifier has a 5.1 sound channel signal output port for connecting to other corresponding function devices.

3. The 5.1 sound channel digital surround earphone of claim 1, wherein the amplification circuit has an output end coupled with a 7-pin socket mating a 7-pin plug on a connection end of the line controller.

4. The 5.1 sound channel digital surround earphone of claim 1, wherein the amplification circuit includes an Integrated circuit to amplify power, the Integrated circuit being connected to an audio bypass circuit and a coupling capacitor.

5. The 5.1 sound channel digital surround earphone of claim 1, wherein the line controller has a switch for switching CD and DVD and a potentiometer to control the sound volume of the earphone.
